(19) United States
(12) Patent Application Publication
(10) Pub. No.: US 2025/0325344 A1
(43) Pub. Date: Oct. 23, 2025

(54) SPATULA WITH INTERCHANGEABLE ENDPIECE AND ADJUSTABLE ANGLE

(71) Applicants: Simone Melara MANSSUR, Porto Alegre (BR); Rafael MELARA, Porto Alegre (BR)

(72) Inventors: Simone Melara MANSSUR, Porto Alegre (BR); Rafael MELARA, Porto Alegre (BR)

(21) Appl. No.: 18/863,520

(22) PCT Filed: Dec. 20, 2022
(86) PCT No.: PCT/BR2022/050513

§ 371 Date: Nov. 6, 2024

(30) Foreign Application Priority Data
May 9, 2022 (BR) 1020220089361

(51) Int. Cl. A61C 3/00

(52) U.S. Cl. CPC A61C 3/00

(57) ABSTRACT

The spatula with an interchangeable tip and adjustable angle of the invention comprises a rod (2) for fitting the tips (3), which are dental tools, fittings for scalpels, brushes, or similar items, by means of a joint (3-A) in a cylindrical shape with external teeth that are coupled to the housing (2-B-3) of the trigger (2-B), which allows the tip (3) to be angled, and is pressed by a spring (4), when extended, against the tip (2-D) securing the tip (3). The change in tools is carried out by activating the triggers (2-B), which compresses the springs (4), releasing the joints (3-A), and allowing the tips (3) to be changed.

### TECHNICAL SECTOR

The present invention belongs to the technological sector of dentistry, more specifically to tools for dentistry, being related to a spatula with an interchangeable tip having an adjustable angle, comprising a rod with an interchangeable tip, which tips are the tools used by health professionals and preferably dental tools, eliminating the need to have multiple devices, replacing them with a wide variety of tips.

### STATE OF THE ART

In dentistry, for the treatment of different types of dental problems, over the years, different tools have been developed to meet the needs of professionals. Currently, for professionals to perform their work, there is a need to acquire many tools to execute different techniques, addressing dental complications. These tools, despite solving the problems, generate inconveniences for the professional; among which are the need to acquire all the tools that occupy a large space in the work environment, the high investment cost, and the limitation of the angle of the tools, which are usually fixed, making it difficult to perform the work.

Patent document DE591227 describes a cupped rod for dental wax work comprising a rod with a cupped tip fixed by means of a ball joint, spring, and screw. A limitation of this type of rod is the fixation by a ball joint that does not securely fix the tip, allowing it to move during use. This necessitates the use of a screw on the rod, which requires a special tool for the replacement/maintenance thereof, thus eliminating the practicality that the invention should provide. Another limitation of this rod is the inability to use different tools besides the wax ladle.

Patent document FR1583476 describes a rod with a tip for manual activation, replacing the use of electric motor power, thus giving the user better control of the tool. This rod has the limitation of being used only for root canal procedure and using a bolted ball joint, which does not provide versatility and ease to the user, as it requires the screw to ensure rigidity.

US patent document 5,055,106 describes a scalpel with a shank attachable by means of a ball joint and screwing mechanism. This set has the limitation of using the tip only as a scalpel and containing a ball joint for tip angulation, requiring a screw to bring rigidity to the connection, making its maintenance difficult.

### NOVELTIES AND OBJECTIVE OF THE INVENTION

The present invention is aimed at a dental instrument (spatula) for the insertion and sculpting of composite resin (restorative material) during restorations. This instrument features different interchangeable tips with adjustable angles to facilitate the instrument's access to various regions of the dental structure. The tips of the instrument can have the most varied shapes of active ends of dental spatulas, hair and silicone brushes, odontoscopes (dental mirrors), as well as fittings for scalpel blades, effectively addressing the limitations of the prior art mentioned above.

The spatula comprises a rod with an interchangeable tip for coupling to the rod with a gear-shaped joint. The present invention contains a two-sided rod with interchangeable tips where the same or different tools can be used, according to the task that is performed. The tip and the rod are fixed to each other by means of a gear-shaped joint wherein the rod contains a fitting hole for the gear. The joint is fixed by means of a spring that contracts the gear. The tips can be formed by any tool necessary in dentistry.

Optionally, the tip can have a scalpel fitting design and can be used in various fields of medicine and dentistry, as well as in the form of a brush, silicone brush, odontoscope, and explorer probe, among others.

Alternatively, the gear joint can contain more or fewer teeth, varying the angle of the tip.

### ADVANTAGES AND TECHNICAL EFFECTS OF THE INVENTION

The spatula with interchangeable tip, object of the present invention, results in the following advantages and achieves the following technical effects over the spatulas of the state of the art:
The state-of-the-art spatulas contain a ball joint for connection between the tip and the rod, which is not rigid. This is solved by the present invention by means of the rod and tip with a gear-shaped and spring fitting, ensuring the possibility of angulation and rigidity to the instrument;
State-of-the-art spatulas contain limitations regarding the type of instrument that can be used as a rod tip, reducing their versatility. This is solved by the present invention with tips in the shape of any tool necessary for dental services or scalpel fitting;
The state-of-the-art spatulas contain a screw for securing the joint, making it difficult to change and maintain the tip. This is solved by the present invention with a joint in the shape of a gear and spring, providing angulation and rigidity to the assembly, in addition to agility and versatility.
State-of-the-art spatulas contain only one tip end for use in dental procedures, limiting their versatility. This is solved by the present invention with the two ends having fittings for various tips.

### LIST OF ACCOMPANYING DRAWINGS

In order for this invention to be fully understood and put into practice by any person skilled in this technological field, it is now described in a clear, precise and sufficient manner, based on the accompanying drawings, listed below, which illustrate the preferred spatula embodiments:

FIG. 1—perspective view of the spatula;

FIG. 2—perspective view with one side of the spatula exploded;

FIG. 3—front view in longitudinal section of the spatula;

FIG. 4—front view in longitudinal section of the spatula with the spring compressed;

FIG. 5—perspective view of the central body of the spatula;

FIG. 6—perspective view of the spatula trigger;

FIG. 7—perspective view of the upper body of the spatula;

FIG. 8—enlarged perspective view of the tip as a dental tool;

FIG. 9—enlarged perspective view of the tip as a scalpel socket; and

FIG. 10—front sectional view of the spatula alternative with a variation of 20 by 20 degrees.

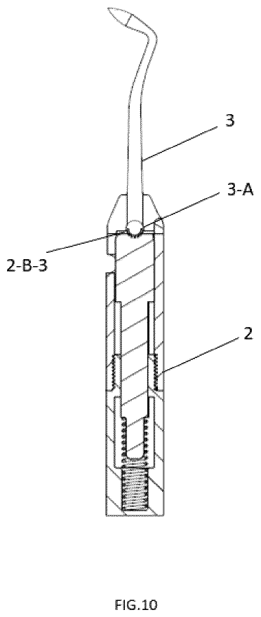

### DETAILED DESCRIPTION OF THE INVENTION

The present invention discloses a spatula with an interchangeable tip and adjustable angle (1) that comprises a rod (2) consisting of a central body (2-A), two triggers (2-B), two upper bodies (2-C), two tips (2-D), and two springs (4) that receive two tips (3) at the ends thereof.

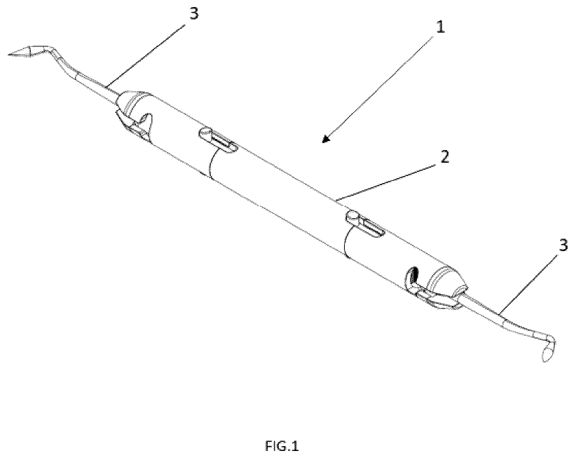

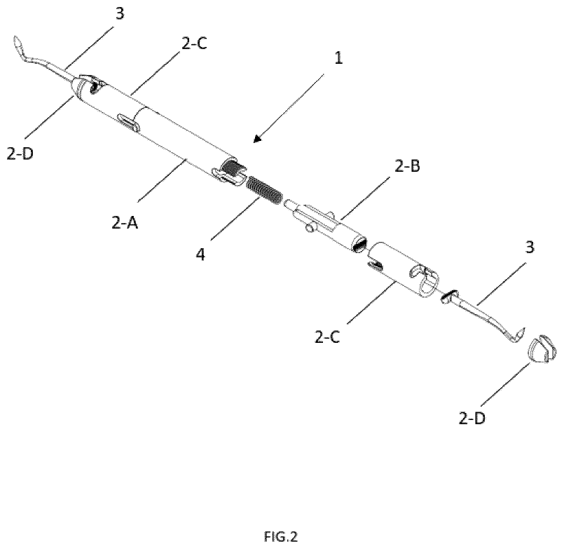

FIGS. 1, 2, 3, and 4 illustrate the spatula with an interchangeable tip and adjustable angle (1), which comprises a rod (2) for fitting the tips (3), which are a dental tool, scalpel fitting, or similar, by means of a cylindrical joint (3-A) with external teeth that engage with the housing (2-B-3) of the trigger (2-B) pressed by the spring (4) when extended against the tip (2-D), securing the tip (3); the spring (4) compresses when the trigger (2-B) is activated, releasing the joint (3-A) and allowing the tip (3) to be changed.

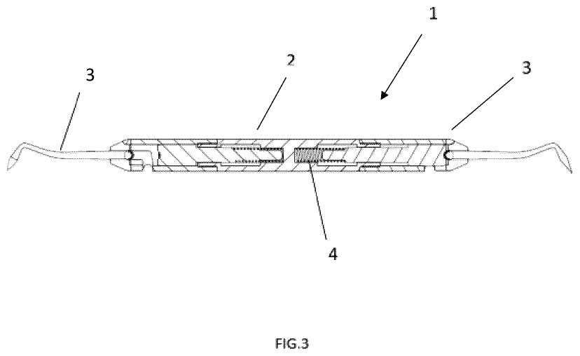

FIG. 3 details the interior of the spatula (1), which shows on the right side the spring (4) extended inside the rod (2), pressing the trigger (2-B) that contains a housing (2-B-3) for fitting the joint (3-A), which is securing the tip (3) to the rod (2); on the left side, the spring (4) is shown contracted by the activation of the trigger (2-B), allowing the tip (3) to be changed through the hole (2-C-3) of the rod (2) for using another tool.

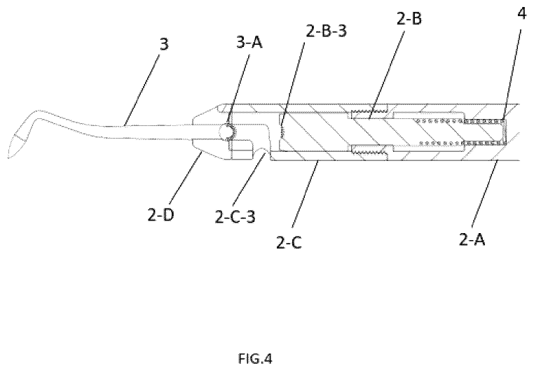

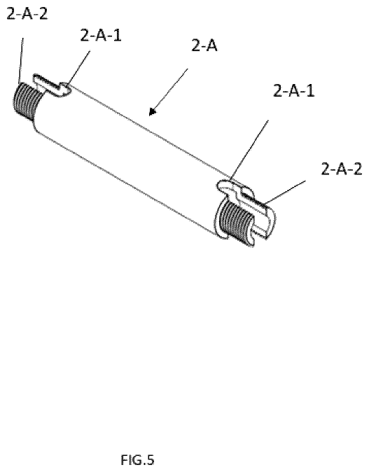

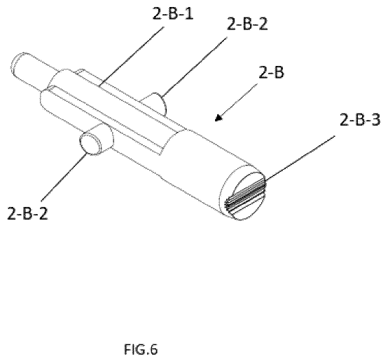

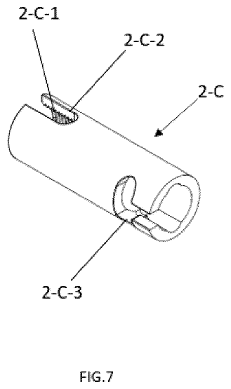

FIGS. 4, 5, 6, and 7 illustrate the rod (2), which consists of a central body (2-A) in a hollow cylindrical shape with holes (2-A-1) and threads (2-A-2) at the ends thereof, wherein the spring (4) is inserted, over which the trigger (2-B) is fitted, and the upper body (2-C) is threaded; by two triggers (2-B) in a stepped cylindrical shape with a central recess (2-B-1), two protrusions (2-B-2), and a housing (2-B-3) inserted over the spring (4) inside the rod (2) between the central body (2-A) and the upper body (2-C), fitting into the joint (3-A); by means of two upper bodies (2-C) in a hollow cylindrical shape with a thread (2-C-1) containing a hole (2-C-2) and an orifice (2-C-3) threaded to the central body (2-A) and fitted to the tip (2-D), with the spring (4), trigger (2-B), and tip (3) fitted inside; the tip (2-D) having a conical shape with a central hole surrounding the tip (3) and recesses fixed to the upper body (2-C).

The rod (2) contains two equal sides, i.e., it is possible to use two tips (3) with the same or different tools at each end of the spatula.

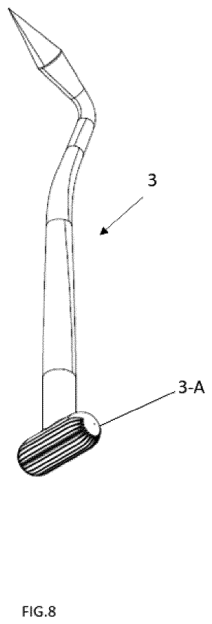

Preferably, the rod is made of stainless-steel, but it is not limited to this. FIG. 8 details an example of a tip (3) wherein the joint (3-A) is seen in a rounded cylindrical shape with teeth, whereby said shape makes the connection between the tip (3) and the rod (2) rigid and allows the tip to be angled every 15 degrees to facilitate the user's work. Alternatively, the tip (3) can have various shapes, but the joint (3-A) always has the same shape to enable it to fit onto the rod (2).

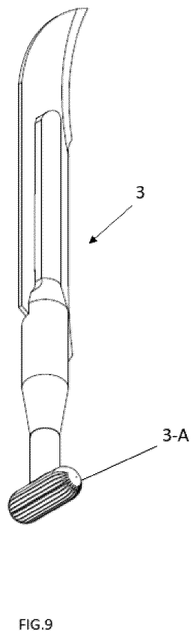

FIGS. 8 and 9 detail the tips (3) of the invention, exemplifying two different types, FIG. 8 with a dental tool and FIG. 9 with a scalpel socket, but the invention is not limited to just these tools, whereby the tip (3) can contain any tool used in dental processes.

Preferably the tip is made of titanium, but not limited to this material.

Alternatively, the joint (3-A) and the housing (2-B-3) are coupled in such a way that the teeth allow the angle of the tip (3) to vary by 20° increments.

Alternatively, the joint (3-A) and the housing (2-B-3) are coupled in such a way that the teeth allow the angle of the tip (3) to be varied at any angle.

It should be noted that the drawings and description presented are not intended to limit the ways in which the inventive concept proposed herein can be implemented, but to illustrate and make understandable the conceptual innovations revealed by the invention. Thus, the descriptions and images should be interpreted in an illustrative and not limiting way, and there may be other equivalent or analogous forms of implementation that should be considered within the scope of this invention.

This specification is related to a spatula with an interchangeable tip and adjustable angulation that results in a new technical effect in relation to the prior art, thus evidencing the novelty, inventive activity, descriptive sufficiency [full disclosure], and industrial application thereof, meeting all the requirements for being granted a patent of invention.

1-6. (canceled)

7. A spatula with interchangeable tip and adjustable angle comprising a rod for fitting two tips which are a dental tool, scalpel, or similar tool, using a cylindrical joint with external teeth coupled to a trigger housing of a trigger, thereby enabling angulation of the tips, wherein the trigger is pressed by a spring, when extended against a rod tip holding one of the two tips, wherein the spring compresses when the trigger is activated, releasing the cylindrical joint and allowing the tip to be changed.

8. The spatula with interchangeable tip and adjustable angle, according to claim 7, characterized by:
the rod having a central body in a hollow cylindrical shape with holes and threads at the ends thereof, in which the spring is inserted, and the trigger is fitted over the spring, and an upper body is threaded;
two triggers in a stepped cylindrical shape with a central recess, two protrusions, and the trigger housing inserted over the spring inside the rod between the central body and the upper body and fitting to the cylindrical joint;
two upper bodies in a hollow cylindrical shape with thread containing a hole and an orifice threaded to the central body and fitted to the rod tip, with spring, trigger, and rod tip fitted inside; and
the rod tip with a conical shape with a central hole surrounding the tip and recesses fixed to the upper body.

9. The spatula with interchangeable tip and adjustable angle, according to claim 7, characterized by the cylindrical joint and the trigger housing being coupled whereby the teeth allow an angle of the tip to vary by 15° increments.

10. The spatula with interchangeable tip and adjustable angle, according to claim 7, characterized by the cylindrical joint and the trigger housing being coupled whereby the teeth allow an angle of the tip to vary by 20° increments.

11. The spatula with interchangeable tip and adjustable angle, according to claim 7, characterized by the cylindrical joint and the trigger housing being coupled whereby the teeth allow a variation of an angle of the tip within a desired range.
